(19) United States
(12) Patent Application Publication
(10) Pub. No.: US 2008/0014907 A1
(43) Pub. Date: Jan. 17, 2008

(54) Method for Call Completion Service

(75) Inventor: Sea Gon Chun, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom Korea Limited

(21) Appl. No.: 10/556,274

(22) PCT Filed: May 28, 2004
(86) PCT No.: PCT/KR04/01274

§ 371 Date: Nov. 24, 2006

(30) Foreign Application Priority Data
May 30, 2003 (KR) 10-2003-0034806

(51) Int. Cl. H04M 3/428; H04M 3/42; H04M 3/48

(52) U.S. Cl. 455/414.1; 455/414.2; 455/417; 455/466

(57) ABSTRACT

The present invention provides a call completion service that notifies a calling subscriber when a called terminal becomes available for connection. This is upon the request of the calling subscriber to address situations such as when a call is unable to be established due to the called terminal being busy or turned off. The calling subscriber can also monitor the status of the called terminal through the service. Thus, the present invention can reduce the number of call attempts, thereby improving the stability of the communication system.

### TECHNICAL FIELD

The present invention relates to a method for a call completion service in a mobile communication system. More particularly, the present invention relates to a method to implement a call completion service that notifies a calling subscriber when a called terminal becomes assailable for connection. This is upon the request of the calling subscriber to address situations such as when a call is unable to be established due to the called terminal being busy or turned off. According to the present invention, if the terminal of a called subscriber is powered off, then a Home Location Register (HLR) recognizes and handles such situation. If the terminal of a called subscriber is busy, then a Mobile Switching Center (MSC) recognizes and handles such situation. Further, if the terminal of a called subscriber becomes available for connection, then a Call Completion Service server cooperates with a Short Message Center (SMC). This is to notify the calling subscriber about the status of the called terminal by using a Short Message Service (SMS). Therefore, the present invention can reduce the number of call attempts, thereby improving the stability of the communication system.

### BACKGROUND ART

According to the present invention, a Call Completion Service (CCS) is a type of service designed for situations such as when a called terminal cannot be reached. Upon the request of the calling subscriber, when the called terminal becomes assailable for connection, the CCS notifies the calling subscriber about the status of the called terminal by using a SMS.

As a new service in a communication network, the CCS cooperates with the MSC (Mobile Station Center), HLR (Home Location Register), SMC (Short Message Center), and CCS (Call Completion Service) server in order to use the SMS (Short Message Service) for notifying a calling subscriber.

### DISCLOSURE OF THE INVENTION

The object of the present invention is to provide a call completion service that notifies a calling subscriber when the called terminal becomes available for connection. This is upon the request of the calling subscriber to address situations such as when a call cannot be established because the called terminal is busy or turned off. The calling subscriber can also monitor the status of the called terminal through the service. Thus, the present invention can reduce the number of call attempts to thereby improve the stability of the communication system.

To accomplish said object, if a called terminal is powered-off; the method for a Call Completion Service (CCS) according to the present invention comprises the following steps: at a Home Location Register (HLR) which receives a LocationRequest MAP, performing a RUIDIR (Remote User Interactive Directive) MAP and querying a calling subscriber whether to request the CCS; at the HLR, setting an ADR (Access Deny Reason) of a LocationRequest Return Result, which returns in response to the LocationRequest, as Inactive and terminating the call; at the HLR, monitoring a power-on location registration of a called terminal and if the power-on location registration is requested by a mobile terminal thereafter, then notifying a CCS-server using a ServiceRequest MAP; and at the CCS-server, notifying a calling subscriber that the called terminal is available for connection by using a Short Message Service(SMS) in cooperation with a SMC(Short Message Center).

Further, to accomplish said object, if a called terminal is busy in the case of a local call, the method for a CCS according to the present invention comprises the following steps: at a MSC, paging the called terminal to detect that the called terminal is busy and querying a calling subscriber whether to request the CCS by using a TransferToNumberRequest MAP; at a HLR which receives the TransferToNumberRequest, confirming the CCS request, transmitting RUIDIR to the MSC thereafter and querying the calling subscriber whether to request the CCS; at the HLR, setting an ADR of a TransferToNumberRequest Return Result, which returns in response to the TransferToNumberRequest, as Busy and terminating the call; transmitting an ActiveTraceMode to the MSC to detect the idle status of a called terminal and monitoring the called terminal thereafter; if the called terminal is normally terminated during the monitoring, detecting a status change of the called terminal at the MSC and transmitting ReportTraceSubscriberActivity (RTSA) to the HLR to notify the status change of the called terminal; at the HLR, notifying a CCS-server of the status change using a ServiceRequest; and at the CCS-server, notifying a calling terminal of the status change by using a SMS in cooperation with a SMC.

Moreover, to accomplish said object, if a called terminal is busy in the case of an international call, the method for a CCS according to the present invention comprises the following steps: at a HLR, recognizing a call as an international call when a LocationRequest is received and performing a RoutingRequest Map to a MSC; at the MSC, confirming that the status of a called terminal is busy and returning a RoutingRequest Return Result after setting an ADR of the RoutingRequest Return Result as Busy; at the HLR which recognizes that the called terminal is busy, if a calling subscriber is confirmed as a CCS subscriber, then performing a ServiceRequest to request CCS to a CCS-server and performing a RUIDIR to query the calling subscriber whether to perform the CCS; at the HLR, setting an ADR of a LocationRequest Return Result as Busy and terminating the call; at the HLR, transmitting an ActiveTraceMode to the MSC to detect the idle status of a called terminal; if the called terminal is normally terminated, then detecting a status change of the called terminal at the MSC and transmitting ReportTraceSubscriberActivity (RTSA) to the HLR to notify the status change of the called terminal; at the HLR, notifying a CCS-server of the status change using a ServiceRequest; and at the CCS-server, notifying a calling terminal of the status change by using a SMS in cooperation with a SMC.

The present invention provides a call completion service that notifies a calling subscriber when the called terminal becomes available for connection. This is upon the request of the calling subscriber to address situations such as when a call is unable to be established due to the called terminal being busy or turned off. The calling subscriber can also monitor the status of the called terminal through the service. Thus, the present invention can reduce the number of call attempts and increase the success rate of calls. Accordingly, the stability of the communication system can be improved.

### BRIEF DESCRIPTION OF DRAWINGS

FIG. 1 shows a diagram illustrating a method for a call completion service according to the present invention when a called terminal is powered-off.

FIG. 2 shows a diagram illustrating a method for a call completion service according to the present invention when a called terminal is busy in the case of a local call.

FIG. 3 shows a diagram illustrating a method for a call completion service according to the present invention when a called terminal is busy in the case of an international call.

### BEST MODE FOR CARRYING OUT THE INVENTION

The preferred embodiment of the method for call completion service of the present invention, which is in accordance with the above-specified technical features of the present invention, will now be described in detail with reference to the accompanying drawings.

In a communication network, the CCS according to the present invention is a new type of service that cooperates with the MSC (Mobile Station Center), HLR (Home Location Register), SMC (Short Message Center), CCS (Call Completion Service) server in order to employ the SMS (Short Message Service) for notifying a calling subscriber. Also, the present invention defines the function of the MSC in implementing the CCS.

As described above, the CCS is a service designed for situations such as when a called terminal cannot be reached. Upon the request of the calling subscriber, when the called terminal becomes available for connection, the CCS notifies the calling subscriber about the status of the called terminal by using a SMS.

There are mainly three situations in which a called terminal cannot be reached: a called terminal is powered off; a called terminal is busy in the case of a local call; and a called terminal is busy in the case of an international call. For each of these cases, the operation according to the embodiment of the present invention is described below with reference to the accompanying drawings.

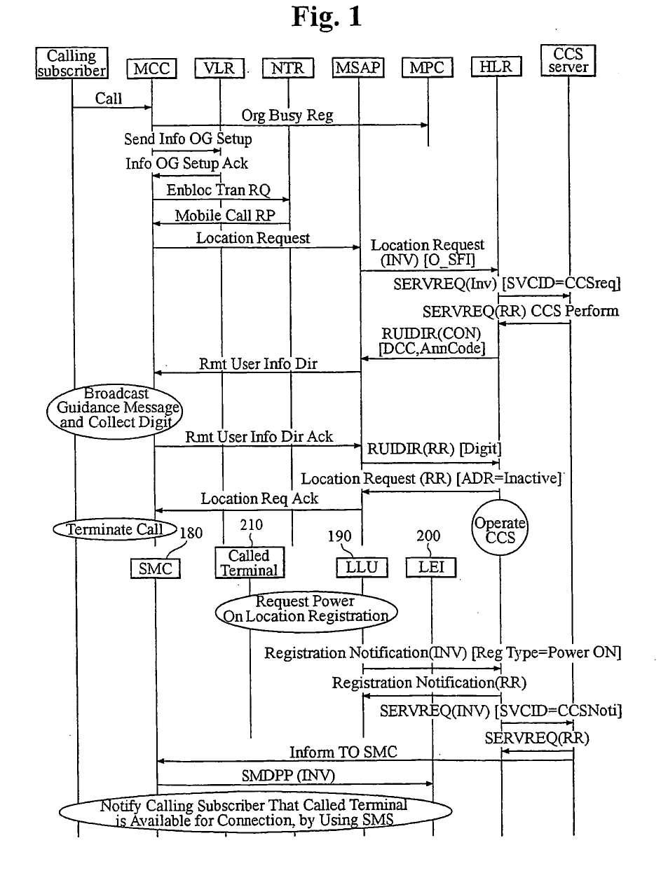

FIG. 1 shows a diagram illustrating a method for a call completion service according to the present invention when a called terminal is powered-off.

As shown in FIG. 1, for instances in which a called terminal is powered-off, the method for a Call Completion Service (CCS) according to the present invention comprises the following steps: at a HLR 160 which receives a LocationRequest MAP, performing a RUIDIR (RemoteUserInteractiveDirective) MAP and querying a calling subscriber 100 whether to request the CCS; at the HLR, setting an ADR (Access Deny Reason) of a LocationRequest Return Result, which returns in response to the LocationRequest, as Inactive and terminating the call; at the HLR, monitoring a power-on location registration of a called terminal and if the power-on location registration is requested by a mobile terminal thereafter, then notifying a CCS-server 170 using a ServiceRequest MAP; and at the CCS-server, notifying a calling subscriber that the called terminal is available for connection by using a Short Message Service(SMS) in cooperation with a SMC(Short Message Center).

This method is better described below as a non-limitative embodiment and with reference to the accompanying drawing.

Since an indication whether the called terminal is powered-off is stored in the HLR 160 subscriber database, a RUIDIR (RemoteUserInteractiveDirective) MAP is performed and a calling subscriber 100 is queried whether to request the CCS at the HLR 160 which receives a LocationRequest Map.

Then, HLR 160 sets an ADR (Access Deny Reason) of a LocationRequest Return Result, which returns in response to the LocationRequest, as Inactive and terminates the call.

After terminating the call, at the HLR 160, a power-on location registration of a called terminal is monitored and if a mobile terminal requests the power-on location registration, then the request is notified to the CCS-server 170 by using a ServiceRequest MAP.

The CCS-server 170 then notifies a calling subscriber that the called terminal is available for connection by using a Short Message Service (SMS) in cooperation with a SMC (Short Message Center).

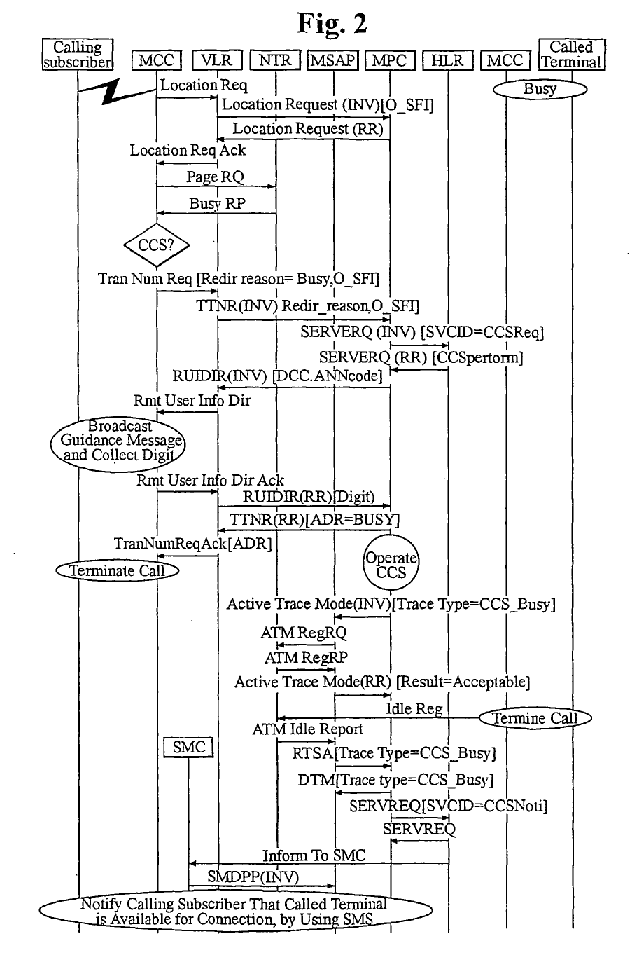

FIG. 2 shows a diagram illustrating a method for a call completion service according to the present invention when a called terminal is busy in the case of a local call.

As shown in FIG. 2, if a called terminal is busy in the case of a local call, the method for a CCS according to the present invention comprises the following steps: at a MSC, paging the called terminal to detect that the called terminal is busy and querying a calling subscriber whether to request the CCS by using a TransferToNumberRequest MAP; at a HLR which receives the TransferToNumberRequest, confirming the CCS request, transmitting RUIDIR to the MSC thereafter and querying the calling subscriber whether to request the CCS; at the HLR, setting an ADR of a TransferToNumberRequest Return Result, which returns in response to the TransferToNumberRequest, as Busy and terminating the call; transmitting an ActiveTraceMode to the MSC to detect the idle status of a called terminal and monitoring the called terminal thereafter; if the called terminal is normally terminated during the monitoring, detecting a status change of the called terminal at the MSC and transmitting ReportTraceSubscriberActivity (RTSA) to the HLR to notify the status change of the called terminal; at the HLR, notifying a CCS-server of the status change using a ServiceRequest; and at the CCS-server, notifying a calling terminal of the status change by using a SMS in cooperation with a SMC.

This method is better described below as a non-limitative embodiment.

Since the HLR cannot recognize whether the called terminal is busy, it may not perform the RUIDIR (RemoteUserInteractiveDirective) normally in the LocationRequest MAP.

Therefore, the MSC pages the called terminal in order to detect that the called terminal is busy and then queries a calling subscriber whether to request the CCS. This is when the TransferToNumberRequest MAP is used.

Then, the HLR, which receives the TransferToNumberRequest, confirms the CCS request and transmits the RUIDIR to the MSC in order to query the calling subscriber whether to request the CCS.

The HLR subsequently sets an ADR of a TransferToNumberRequest Return Result, which returns in response to the TransferToNumberRequest, as Busy and terminates the call. It then transmits an ActiveTraceMode to the MSC to detect the idle status of a called terminal and monitors the called terminal thereafter.

If the called terminal is normally terminated during the monitoring, then the MSC detects a status change of the called terminal. It then transmits the RTSA (ReportTraceSubscriberActivity) to the HLR to notify the status change of the called terminal.

The HLR, which receives the RTSA, notifies the CCS-server about the status change using a ServiceRequest. Then, the CCS-server notifies a calling terminal about the status change by using a SMS in cooperation with a SMC.

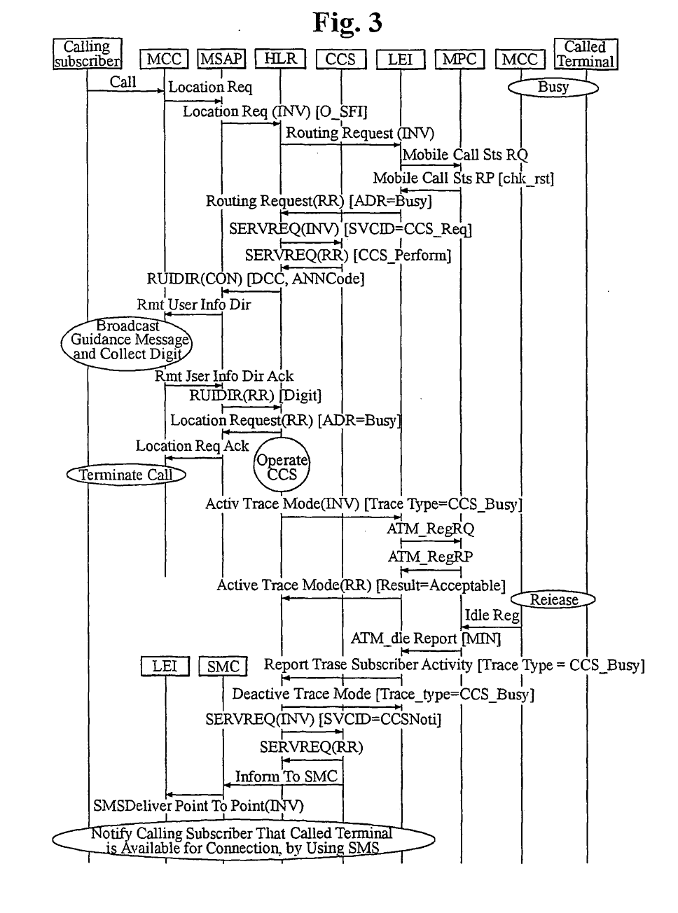

FIG. 3 shows a diagram illustrating a method for a call completion service according to the present invention when a called terminal is busy in the case of an international call.

As shown in FIG. 3, if a called terminal is busy in the case of an international call, the method for a CCS according to the present invention comprises the following steps: at a HLR, recognizing a call as an international call when a LocationRequest is received and performing a RoutingRequest Map to a MSC; at the MSC, confirming that the status of a called terminal is busy and returning a RoutingRequest Return Result after setting an ADR of the RoutingRequest Return Result as Busy; at the HLR which recognizes that the called terminal is busy, if a calling subscriber is confirmed as a CCS subscriber, then performing a ServiceRequest to request CCS to a CCS-server and performing a RUIDIR to query the calling subscriber whether to perform the CCS; at the HLR, setting an ADR of a LocationRequest Return Result as Busy and terminating the call; at the HLR, transmitting an ActiveTraceMode to the MSC to detect the idle status of a called terminal; if the called terminal is normally terminated, then detecting a status change of the called terminal at the MSC and transmitting ReportTraceSubscriberActivity (RTSA) to the HLR to notify the status change of the called terminal; at the HLR, notifying a CCS-server of the status change using a ServiceRequest; and at the CCS-server, notifying a calling terminal of the status change by using a SMS in cooperation with a SMC.

This method is described in greater detail below as a non-limitative embodiment.

Initially, the HLR, which receives a LocationRequest, recognizes the call as an international call and performs a RoutingRequest Map to the MSC.

Since the MSC is able to know that the status of a called terminal is busy, it returns the RoutingRequest Return Result after setting the ADR of the RoutingRequest Return Result as Busy.

Meanwhile, the HLR, which recognizes that the called terminal is busy, confirms if a calling subscriber is a CCS subscriber. Then, it performs a ServiceRequest to request CCS to a CCS-server and performs a RUIDIR to query the calling subscriber whether to perform the CCS.

In addition, the HLR sets ADR of a LocationRequest Return Result as Busy and terminates the call.

The HLR also transmits an ActiveTraceMode to the MSC to detect the idle status of a called terminal.

If the called terminal is normally terminated, then the MSC detects a status change of the called terminal and transmits RTSA (ReportTraceSubscriberActivity) to the HLR to notify the status change of the called terminal.

The HLR, which receives the RTSA, notifies the CCS-server about the status change using a ServiceRequest. The CCS-server then notifies the calling terminal about the status change by using a SMS in cooperation with a SMC.

Although the present invention was described with respect to a particular embodiment of the method for call completion service, it will be apparent to those skilled in the art that many changes and modifications may be made without departing from the scope of the invention as defined in the appended claims and those equivalent thereto.

1. A method for Call Completion Service (CCS) in a mobile communication system, if a called terminal is powered-off, comprising the steps of:
at a Home Location Register (HLR), which receives a LocationRequest MAP, performing a RUIDIR (RemoteUserInteractiveDirective) MAP and querying a calling subscriber whether to request the CCS;
at the HLR, setting an ADR (Access Deny Reason) of a LocationRequest Return Result, which returns in response to the LocationRequest, as inactive and terminating the call;
at the HLR, monitoring a power-on location registration of a called terminal, and thereafter if the power-on location registration is requested by a mobile terminal, notifying a CCS-server using a ServiceRequest MAP; and
at the CCS-server, notifying a calling subscriber that the called terminal is available for connection by using a Short Message Service(SMS) in cooperation with a SMC (Short Message Center).

2. The method of claim 1, wherein a HLR subscriber database stores an indication whether the called terminal is powered-off, and
at the Home Location Register (HLR), which receives the LocationRequest MAP, the RUIDIR (RemoteUserInteractiveDirective) MAP is performed to query the calling subscriber whether to request the CCS.

3. A method for Call Completion Service (CCS) in a mobile communication system, if a called terminal is busy in the case of a local call, comprising the steps of:
at a MSC, paging the called terminal to detect that the called terminal is busy and querying a calling subscriber whether to request the CCS by using a TransferToNumberRequest MAP;
at a HLR which receives the TransferToNumberRequest, confirming the CCS request, transmitting RUIDIR to the MSC thereafter and querying the calling subscriber whether to request the CCS;
at the HLR, setting an ADR of a TransferToNumberRequest Return Result, which returns in response to the TransferToNumberRequest, as Busy and terminating the call;
transmitting an ActiveTraceMode to the MSC to detect the idle status of a called terminal and thereafter monitoring the called terminal;
if the called terminal is normally terminated during the monitoring, detecting a status change of the called terminal at the MSC and transmitting ReportTraceSubscriberActivity (RTSA) to the HLR to notify the status change of the called terminal;
at the HLR, notifying a CCS-server of the status change using a ServiceRequest; and
at the CCS-server, notifying a calling terminal of the status change by using a SMS in cooperation with a SMC.

4. A method for Call Completion Service (CCS) in a mobile communication system, if a called terminal is busy in the case of an international call, comprising the steps of:
at a HLR, recognizing a call as an international call when a LocationRequest is received and performing a RoutingRequest Map to a MSC;
at the MSC, confirming that the status of a called terminal is busy and returning a RoutingRequest Return Result after setting an ADR of the RoutingRequest Return Result as Busy;
at the HLR which recognizes that the called terminal is busy, if a calling subscriber is confirmed as a CCS subscriber, then performing a ServiceRequest to request CCS to a CCS-server and performing a RUIDIR to query the calling subscriber whether to perform the CCS;
at the HLR, setting an ADR of a LocationRequest Return Result as Busy and terminating the call;
at the HLR, transmitting an ActiveTraceMode to the MSC to detect the idle status of a called terminal;
if the called terminal is normally terminated, then detecting a status change of the called terminal at the MSC and transmitting ReportTraceSubscriberActivity (RTSA) to the HLR to notify the status change of the called terminal;
at the HLR, notifying a CCS-server of the status change using a ServiceRequest; and
at the CCS-server, notifying a calling terminal of the status change by using a SMS in cooperation with a SMC.
